(19) United States
(12) Patent Application Publication
(10) Pub. No.: US 2021/0063202 A1
(43) Pub. Date: Mar. 4, 2021

(54) METHOD FOR CREATING A MAP AND METHOD AND DEVICE FOR OPERATING A VEHICLE

(71) Applicant: Robert Bosch GmbH, Stuttgart (DE)

(72) Inventors: Tobias Strauss, Obersulm (DE); Carsten Hasberg, Ilsfeld-Auenstein (DE)

(21) Appl. No.: 16/933,079

(22) Filed: Jul. 20, 2020

(30) Foreign Application Priority Data
Sep. 3, 2019 (DE) 102019213318.5

(51) Int. Cl. G01C 21/00

(52) U.S. Cl. CPC G01C 21/3859; G01C 21/3837; G01C 21/3822

(57) ABSTRACT

A method for creating a map based on a base map and as a function of at least one luminous surroundings feature, as well as a method and device for operating a vehicle as a function of a feature classification of a luminous surroundings feature.

### CROSS REFERENCE

The present application claims the benefit under 35 U.S.C. § 119 of German Patent Application No. DE 102019213318.5 filed on Sep. 3, 2019, which is expressly incorporated herein by reference in its entirety.

### FIELD

The present invention relates to, among other things, a method for creating a map and to a method for operating a vehicle as a function of this map.

### SUMMARY

An example method according to the present invention for creating a map includes a step of receiving surroundings data values, which represent drivable surroundings, the drivable surroundings including at least one stationary, luminous surroundings feature, the surroundings data value including a position of the at least one stationary luminous surroundings feature. The method further includes the step of providing a base map, the base map representing at least one area that includes the drivable surroundings of the vehicle, and a step of creating the map based, in particular, on the base map, as a function of the at least one stationary luminous surroundings feature.

The at least one stationary luminous surroundings feature is understood to mean a fixed object, which is designed to emit light by itself and/or to reflect light of another source.

A base map is understood to mean, for example, map data, which represent a map, the base map including, in particular, at least one road network, individual features of the road network (intersections, road course, road width, traffic signs, etc.) being stored, for example, in GNSS coordinates.

The example method according to the present invention for operating a vehicle includes a step of detecting surroundings data values that represent the surroundings of the vehicle, the surroundings including a luminous surroundings feature, and a step of carrying out a comparison of the surroundings data values with a map, which has been created according to the method according to the present invention for creating a map. The method further includes a step of determining a feature classification of the luminous surroundings feature based on the comparison, and a step of operating the vehicle as a function of the feature classification.

A vehicle is understood to mean a manually operated (designed according to SAE-Level 0) or an automated vehicle (designed according one of the SAE Levels 1 through 5) (see SAE J3016 Standard).

A luminous surroundings feature is understood to mean, for example, an object, which is designed to emit light by itself and/or to reflect light of another source—in particular, by an illuminant of the vehicle. An illuminant is understood to mean at least one light-emitting source (headlight, turn signal, rear light, etc.) of the vehicle. Another source is understood to mean, for example, also light from the headlights of another road user, etc.

A feature classification of the luminous surroundings feature is understood in one specific embodiment to mean, for example, a classification as “relevant for the vehicle” or “not relevant for the vehicle.” The relevance in this case refers, for example, to the safety of the vehicle or to the safety of additional road users. For example, a luminous surroundings feature, which is identified as a traffic light based on the comparison previously carried out, is classified as not relevant. A luminous surroundings feature, which has not been identified based on the comparison previously carried out (since no corresponding object is found in the map), is classified as relevant, since it could potentially involve headlights of an additional vehicle or reflections of an additional road user (reflectors of a bicycle, etc.). In a further specific embodiment of the present invention, the feature classification additionally or alternatively includes detailed information regarding the luminous surroundings feature (configuration of a traffic sign [reflecting sign or self-luminous traffic light], movement direction of an additional road user relative to the vehicle (rear lights or front lights], etc.).

The example method according to the present invention may advantageously achieve the object of optimizing the operation of a vehicle as a function of luminous surroundings features. This object may be achieved with the aid of the example method according to the present invention by comparing luminous surroundings features detected by the vehicle with a map and based thereon, determining a feature classification of the luminous surroundings feature. This results, for example, in an improvement of an automatic dimming function. This map may also be used for localization in the dark. With an exact localization, it is possible to project the data stored in the map into the sensor space of the vehicle (for example, the camera image). It is thus possible, for example, to validate and to improve an output of the existing surroundings sensor system for detecting other road users. This results, for example, in an increase in the sensitivity in areas, in which road users are expected due to the road course, and/or to a suppression of false detections or false feature classifications in areas in which reflectors or stationary light sources are mapped, and/or—in particular, in the case of a complete map—to an avoidance of road users falsely classified as not relevant.

The feature classification preferably includes whether the luminous surroundings feature is a road user or another object.

The operation preferably includes an adaptation of at least one illuminant of the vehicle. This is understood to mean, for example, an adaptive light control (automatic dimming, etc.).

The operation preferably includes a localization of the vehicle.

A map that includes luminous surroundings features (static light sources, reflectors, etc.) may also be used to localize the vehicle in the map (if necessary, using additional map contents). The localization represents an important function, in particular, for automated vehicles, since previous knowledge in this regard about the stationary infrastructure may be made drivable to the vehicle. Reflectors and static light sources represent, in particular, for camera-based localization systems, an important addition of other features (roadway markings, etc.), since they significantly improve the operability at night.

The map is preferably requested and/or received at least partly from an external server. This means that the vehicle includes a base map, which is supplemented by a map layer including luminous surroundings features. This advantageously also results in an updating of a corresponding map in the vehicle.

An example device according to the present invention, in particular, a control unit, is configured to carry out all steps of the method for operating a vehicle according to the example embodiments.

In one possible specific example embodiment, the device includes a processing unit (processor, working memory, hard disk) as well as a suitable software in order to carry out the method according to one of the method embodiments. For this purpose, the device includes an interface, which is designed to detect surroundings data values from a (surroundings) sensor system of the vehicle. A detection of the surroundings data values in this case is understood to mean, for example, that the surroundings data values are detected with the aid of the sensor system and received with the aid of the interface of the sensor system. The device further includes, for example, an interface, which is connected to a navigation device in such a way that (map) data values representing a map may be exchanged between the device and the navigation device. In one specific embodiment, the map is encompassed by the device as a result of the map being stored on the hard disk, for example. In one possible specific embodiment of the present invention, the device also includes, for example, a transmitting and/or receiving unit, which is designed to emit and/or to receive—in particular from an external server—data values. In a further specific embodiment of the present invention, the device includes, for example, an interface, with the aid of which data values may be requested and/or received by a—relative to the device—external transmitting and/or receiving unit of the vehicle. The device further includes an interface in order to provide or emit a signal for operating the vehicle—for example, for/to a control unit of the vehicle.

A computer program is also provided, including commands which, when the computer program is executed by a computer, prompt the computer to carry out a method according to one of the method embodiments of the present invention. In one specific embodiment, the computer program corresponds to the software encompassed by the device.

A machine-readable memory medium, on which the computer program is stored, is also provided.

Advantageous refinements of the present invention are described herein.

### BRIEF DESCRIPTION OF THE DRAWINGS

Exemplary embodiments of the present invention are depicted in the figures and are explained in greater detail below.

FIG. 1 shows one exemplary embodiment of the method according to the present invention for creating a map.

FIG. 2 shows one exemplary embodiment of the method according to the present invention for operating a vehicle in the form of a flow chart.

### DETAILED DESCRIPTION OF EXAMPLE EMBODIMENTS

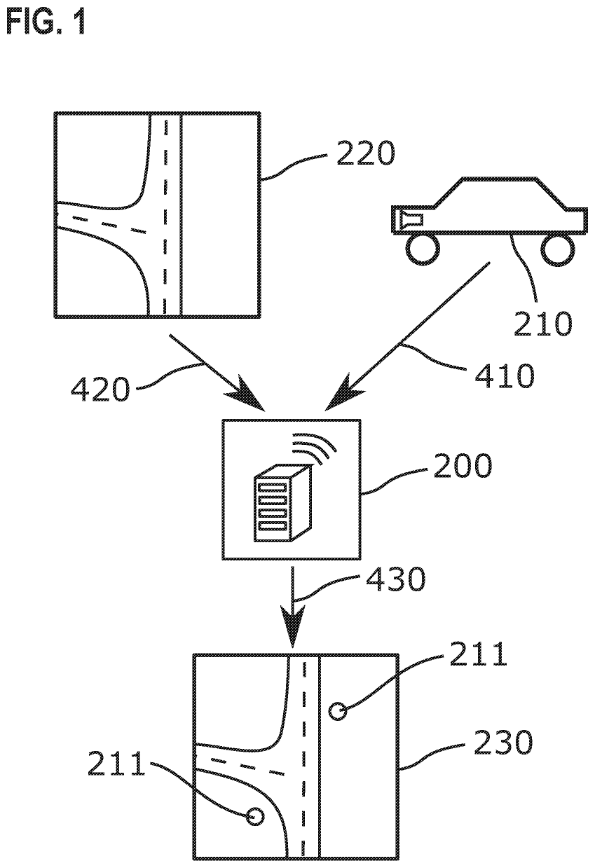

FIG. 1 schematically shows an example method 400 for creating 430 a map 230, method 400 being carried out, for example, by a server 200 (or by a cloud, i.e., by a group of servers).

In this example method, surroundings data values representing drivable surroundings are received, the drivable surroundings including at least one luminous surroundings feature 211, the surroundings data values encompassing a position of the at least one luminous surroundings feature 211. The surroundings data in this case are generated, for example, by a vehicle as a result of the surroundings of the vehicle being detected with the aid of a surroundings sensor system of the vehicle, and are subsequently emitted in the form of surroundings data values for receiving 410 by server 200. In this case, these surroundings data values include a specification of the at least one luminous surroundings feature 211 and, in particular, also a position of the at least one luminous object 211. The specification takes place, for example, in the form of a classification (self-luminous and/or reflecting) and/or of an object description (traffic sign, street light, etc.), the classification and/or the object description being carried out with the aid of an evaluation unit (processor, working memory, hard disk including suitable software). This evaluation unit is encompassed, for example, by the surroundings sensor system or is accordingly connected to the surroundings sensor system. The position is determined, for example, with the aid of a navigation system and/or of another position determining unit and is correspondingly linked to the at least one luminous surroundings feature 211.

A surroundings sensor system is understood to mean at least one video sensor and/or at least one additional sensor, which is designed to detect the surroundings of a vehicle—in particular, in the form of surroundings data values.

Furthermore, a base map 220 is provided, base map 220 representing at least one area that encompasses the drivable surroundings of vehicle 210. In this case, a provision 420 of base map 220 is understood to mean, for example, that base map 220 is downloaded from a memory of server 200 or that base map 220 is requested and/or received from another server in the form of data values.

Map 230 based, in particular, on base map 220 is subsequently created as a function of the at least one luminous surroundings feature 211. A creation 430 of map 230 in this case is understood, for example, to mean that the at least one luminous surroundings feature 211 is inserted into base map 220 in accordance with its position and using the specification (classification and/or object description).

This map 230 is understood, for example, to mean a separate (digital) map or a type of addition or a map layer of a more comprehensive (digital) map, which includes multiple map layers, a map layer showing, for example, a bird's eye view (course and position of roads, buildings, landscape features, etc.). This corresponds, for example, to a map of a navigation system. A further map layer includes, for example, a radar map, the surroundings features depicted by the radar map being stored with a radar signature. A further map layer includes, for example, a LIDAR map, the surroundings features depicted by the LIDAR map being stored with a LIDAR signature, etc.

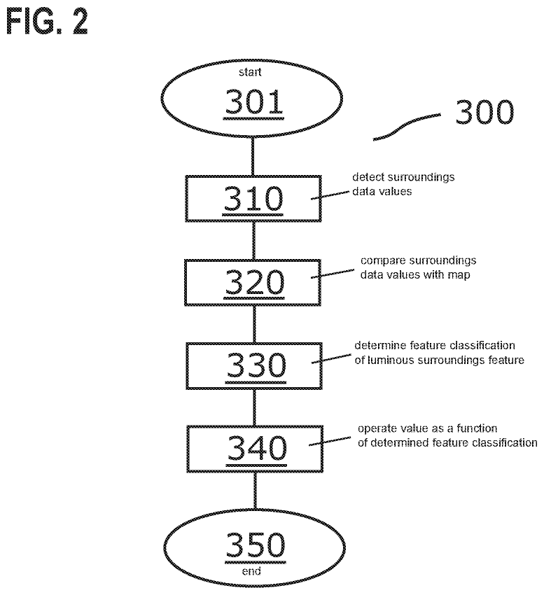

FIG. 2 shows one exemplary embodiment of a method 300 for operating 340 a vehicle in accordance with the present invention.

Method 300 starts in step 301.

In step 310, surroundings data values representing surroundings of the vehicle are detected, the surroundings including a luminous surroundings feature. In the process, the surroundings data values are detected with the aid of a surroundings sensor system of the vehicle, a surroundings sensor system being understood to mean at least one video sensor and/or at least one radar sensor and/or at least one LIDAR sensor and/or at least one additional sensor, which is/are designed to detect surroundings of a vehicle in the form of surroundings data values. In one possible specific embodiment, the surroundings sensor system also includes, for example, a processing unit (processor, working memory, hard disk) including a suitable software and/or is connected to such a processing unit.

In step 320, a comparison of the surroundings data values with a map is carried out, this map having been created, for example, with the aid of method 400 according to the present invention for creating a map 230. In one specific embodiment, the map is requested and/or received from an external server for this purpose, this external server corresponding, for example, to a server 200, which is designed to create and/or to provide a retrievable map 230. A comparison of the surroundings data values with the map is understood, for example, to mean that it is checked with the aid of the map whether a luminous surroundings feature is to be expected as a function of a position of the vehicle and/or as a function of a position of the luminous surroundings feature (relative to the vehicle) (because a luminous surroundings feature is already entered at this position), or not (since no luminous surroundings feature is entered at this position). In a further specific embodiment, the comparison also includes, for example, a comparison of a color and/or of a configuration (form, color gradient, arrangement [height and/or distance to the roadway], etc.).

In step 330, a feature classification of the luminous surroundings feature based on the comparison is determined.

In step 340, the vehicle is operated as a function of the feature classification. In one possible specific embodiment, this is understood to mean, for example, that an occupant of the vehicle is warned if a luminous surroundings feature is classified as relevant. In a further specific embodiment—for example, if the vehicle is designed as an automated vehicle—this is understood to mean that an adaptation of a predefined route takes place and/or that a transverse control and/or longitudinal control of the vehicle is carried out as a function of the feature classification. A velocity of the vehicle is reduced, for example, if a luminous surroundings feature is detected, which is not entered into the map.

Method 300 ends in step 350.

What is claimed is:

1. A method for creating a map, comprising the following steps:
receiving surroundings data values that represent drivable surroundings, the drivable surroundings including at least one luminous surroundings feature, the surroundings data values including a position of the at least one luminous surroundings feature;
providing a base map, the base map representing at least one area, which includes the drivable surroundings of the vehicle; and
creating a map based on the base map, as a function of the at least one luminous surroundings feature.

2. A method for operating a vehicle, comprising the following steps:
detecting surroundings data values representing surroundings of the vehicle, the surroundings including a luminous surroundings feature;
carrying out a comparison of the surroundings data values with a map, which was been created by:
receiving second surroundings data values that represent drivable surroundings, the drivable surroundings including at least one luminous surroundings feature, the surroundings data values including a position of the at least one luminous surroundings feature;
providing a base map, the base map representing at least one area, which includes the drivable surroundings of the vehicle; and
creating the map based on the base map, as a function of the at least one luminous surroundings feature;
determining a feature classification of the luminous surroundings feature based on the comparison; and
operating the vehicle as a function of the feature classification.

3. The method as recited in claim 2, wherein the feature classification includes determining whether the luminous surroundings feature is a road user or another object.

4. The method as recited in claim 2, wherein the operation includes an adaptation of at least one illuminant of the vehicle.

5. The method as recited in claim 2, wherein the operation includes a localization of the vehicle.

6. The method as recited in claim 2, wherein the map is requested at least partly from an external server and/or received at least partly from the external server.

7. A control unit, configured to:
detect surroundings data values representing surroundings of the vehicle, the surroundings including a luminous surroundings feature;
carry out a comparison of the surroundings data values with a map, which was been created by:
receiving second surroundings data values that represent drivable surroundings, the drivable surroundings including at least one luminous surroundings feature, the surroundings data values including a position of the at least one luminous surroundings feature;
providing a base map, the base map representing at least one area, which includes the drivable surroundings of the vehicle; and
creating the map based on the base map, as a function of the at least one luminous surroundings feature;
determine a feature classification of the luminous surroundings feature based on the comparison; and
operate the vehicle as a function of the feature classification.

8. A non-transitory machine-readable memory medium on which is stored computer program for operating a vehicle, the computer program, when executed by a computer, causing the computer to perform the following steps:
detecting surroundings data values representing surroundings of the vehicle, the surroundings including a luminous surroundings feature;
carrying out a comparison of the surroundings data values with a map, which was been created by:
receiving second surroundings data values that represent drivable surroundings, the drivable surroundings including at least one luminous surroundings feature, the surroundings data values including a position of the at least one luminous surroundings feature;
providing a base map, the base map representing at least one area, which includes the drivable surroundings of the vehicle; and
creating the map based on the base map, as a function of the at least one luminous surroundings feature;
determining a feature classification of the luminous surroundings feature based on the comparison; and
operating the vehicle as a function of the feature classification.
